(19) United States
(12) Patent Application Publication
(10) Pub. No.: US 2005/0122955 A1
(43) Pub. Date: Jun. 9, 2005

(54) Method and system for route selection and method for route reconstruction

(76) Inventors: Hwa-Chun Lin, Zhudong Township (TW); Yung-Hwa Chu, Zhonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/842,108

(22) Filed: May 10, 2004

(30) Foreign Application Priority Data
Dec. 5, 2003 (TW) 92134308

(51) Int. Cl. H04L 12/28

(52) U.S. Cl. 370/351; 370/238

(57) ABSTRACT

A method and system for route selection and a method for route reconstruction. A mobile (or ad hoc) wireless network is divided into several clusters, each comprising a plurality of nodes. A source node in a cluster delivers a data packet to a destination node in accordance with a route table thereof if the destination node is located in the same cluster, and, if not, sends a route request packet to the destination node through a gateway node, determining a routing path to the destination node.

### BACKGROUND OF THE INVENTION

1. Field of the Invention

The present invention relates to a method and system for route selection, and in particular to a method and system for hybrid route selection applied in multihop mobile (or ad hoc) wireless networks.

2. Description of the Related Art

Multihop mobile (or ad hoc) wireless networks can be rapidly deployed without the support of fixed infrastructures. Nodes in a multihop mobile (or ad hoc) wireless network are free to move randomly and organize themselves arbitrarily. Therefore, the topology of the network may change rapidly and unpredictably. Each of the nodes in the network acts as a router as well as a host. When a packet is sent from a source node to a destination node that does not reside in the transmission range of the source node, the packet may need to be delivered through one or more intermediate nodes.

In general, routing protocols for ad hoc wireless networks can be classified into three categories, namely, proactive, reactive, and hybrid proactive/reactive protocols.

Proactive protocols calculate routing paths from one node to others according the routing information stored in each node. The most up to date routing information is maintained in each of the nodes such that the routing information is readily available. When the size of the network increases, however, the number of control messages and the delay for obtaining the most up to date routing information will increase.

Reactive (on-demand) protocols employ certain mechanisms, such as flooding, to determine the routing path only when it is required, so that the number of control messages is decreased, enabling the size of the ad hoc wireless network to be expanded. Although reactive protocols can reduce the number of control messages by not maintaining the routing information to all other nodes, errors often occur while sending messages between nodes when the topology of the network changes. The result of such errors is dropping excessive number of packets. In addition, obtaining a new route requires extra control messages and delay.

Hybrid proactive/reactive protocols use proactive protocol in a limited scope and a reactive protocol in global scope. A hybrid protocol is more scalable than a proactive protocol in terms of the overhead required to maintain routing information in each node. A hybrid protocol also incurs less overhead for finding routing paths than a reactive protocol. The zone routing protocol (ZRP) proposed in “A New Routing Protocol for the Reconfigurable Wireless Networks,” Proceedings of IEEE ICUPC'97, by Z. J. Haas is a hybrid protocol.

In the zone routing protocol (ZRP), a routing zone is defined for each of the nodes in the network. The routing zone of a node is centered at the node and includes those nodes within a given number of hops from the node. Thus, the network is consisted of many overlapping routing zones.

When a source node wishes to find a route to a destination node that is not in the routing zone of the source node, the source node sends a route request to each of the nodes on the border of its routing zone. Upon receiving a route request packet, each of the border nodes checks whether the destination node is in its routing zone. If the destination node is in its routing zone, a reply is sent back to the source node. Otherwise, the border node forwards the route request to all of its border nodes. The procedure is repeated until the destination node is found.

### SUMMARY OF THE INVENTION

Accordingly, an objective of the present invention is to provide a method and system for route selection such that the number of control messages can be reduced. In addition, a method is provided to calculate a substitution route when a routing path breaks due to a change in network topology.

According to the objective described, the present invention provides a method and system for route selection. A multihop mobile (or ad hoc) wireless network is divided into several clusters, comprising at least a first cluster and a second cluster connected to each other, each comprising a plurality of nodes, in which the clusters do not overlap with each other. When a source node located in the first cluster wishes to send data packets to a destination node, the source node determines whether the destination node is in the first cluster according to a link state table. If the destination node is located in the first cluster, the source node obtains a first route according to a route table thereof and then delivers the data packet to the destination node through the first route.

If the destination node is not in the first cluster, the source node sends a route request packet to the gateway nodes in the first cluster according to a gateway table of the source node. A gateway node in the first cluster is called the first gateway node. The route request packet is then forwarded from the first gateway node to a second gateway node in the second cluster, seeking a second route to the destination node. If the destination node is located in the second cluster, the second gateway node is able to find the destination node according to a route table thereof, thus obtaining a second route to the destination node. The destination node receives the route request packet through the second route and returns a route reply packet to the source node. Therefore, the source node delivers the data packets to the destination node through the second route. In case that the destination node is not in the second cluster, the route request is further forwarded to neighbor clusters of the second cluster except the first cluster.

The present invention further provides a method for route reconstruction when a route breaks due to a change in network topology. If the link between node M and node N breaks when node M wishes to send a data packet to node N, node M seeks a substitution route connecting nodes M and N according to a route table thereof. If the substitution route is found, data packets are delivered to the destination through the substitution route, and, if not, node M sends a route error packet to the source node, notifying the source node to perform a route discovery procedure to find another route.

Compare with the zone routing protocol, one advantage of the invention is that adjacent clusters do not overlap. The method of the invention substantially decreases the number of control messages generated for exchanging routing information when the size of the network is large. In addition, a substitution route can be rapidly found when a route breaks due to a change in network topology, substantially reducing loss of data packets.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flowchart of the detailed steps of the method for route selection applied to a multihop mobile (or ad hoc) wireless network according to the present invention;

FIG. 2 is a schematic diagram showing a wireless network of the present invention, divided into several clusters;

FIGS. 3 and 4 are schematic diagrams showing a source node according to the present invention seeking a routing path to a destination node;

FIG. 5 is schematic diagram showing the shortest routing path of the present invention from a source node to a destination node;

FIG. 6 is a flowchart of the detailed steps of the method for route reconstruction according to the present invention;

FIG. 7 is schematic diagram showing a substitution routing path of the present invention from a source node to a destination node when a link breaks.

### DETAILED DESCRIPTION OF THE INVENTION

The present invention discloses a method and system for route selection and a method for route reconstruction.

The method of the present invention divides a multihop mobile (or ad hoc) wireless network into several clusters, each comprising a plurality of adjacent nodes. The clusters in the network do not overlap, such that each node belongs to only one of the clusters. Each node has a unique node ID and each cluster has a unique cluster ID (CID), with one of the nodes located in a cluster taking the role of the cluster head. The distance between a cluster head and any node within the same cluster is within a predetermined maximum number of hops.

Furthermore, for routing purpose, each node maintains a link state table, a route table, a gateway table, and a route cache. The link state table maintains the status of all links in the cluster. The route table maintains the shortest path from the node to each of the other nodes in the cluster. The content of the route table is obtained and updated according to the link state table. In each cluster, a node at the border acts as a gateway if the node can communicate directly with one or more border nodes of a neighbor cluster. Information of the gateways in a cluster is maintained in the gateway table. Each entry of the gateway table contains the ID of the gateway, the ID of the node in the neighbor cluster to which the gateway is connected, and the ID of the cluster head of the neighbor cluster. If a gateway connects to two or more neighbor clusters, multiple entries are recorded in the gateway table.

The method of the invention provides the advantages of both proactive and reactive protocols. Within a cluster, a proactive routing protocol is used to maintain the routing information in the cluster. A source node uses its route table to find the routing path to a destination node within the same cluster. The IDs of the nodes on the routing path are included in the packet header such that each of the intermediate nodes uses this information to send the packet to the next node in the path. The path to the destination node is cached in the route cache of source node such that the path can further be used to send subsequent packets to this destination node.

When the status of a link in the cluster changes (e.g., a new link is established or an existing link breaks), the two end nodes of the link send a link state update (LSU) information to notify all other nodes within the same cluster by flooding. The link state update information includes the IDs and CIDs of the two end nodes and the status of the link. Unlike conventional methods, the link state update information does not travel across the boundary of the cluster such that it is flooded only within the cluster. A node that receives the link state update information updates its link state table, route table, and gateway table accordingly.

When a source node wishes to send data packets to a destination node. The source node determines whether the destination node is within the same cluster as the source node. If so, the source node sends the data packets to the destination node in accordance with the route table thereof, and, if not, it sends a route request packet to each of the gateway nodes corresponding to each of the neighbor clusters according to the gateway table thereof.

Each node that forwards the route request packet adds its ID to the packet such that the complete path from the source node to the destination node is obtained when the route request message is received at the destination node.

When a gateway node receives a route request packet from a node that resides in the same cluster as it does, it forwards the route request packet to a gateway node in the neighbor cluster connected to it. If the gateway node is connected to two or more neighbor clusters, the route request packet is forwarded to a gateway node in each of the neighbor clusters.

When receiving a route request packet from a neighbor cluster, a gateway node checks whether the destination node resides in the same cluster as it does according to the linking state table. Based on this information, it determines whether to forward the route request packet to the destination node or to neighbor clusters.

When the destination node receives the route request packet, comprising complete routing information with IDs of the nodes from the source node to the destination node on the routing path, the destination node returns a route reply packet to the source node according to the routing information. The source node delivers the data packets to the destination node using a source routing protocol after receiving the route reply packet.

In addition, a method for finding a substitution route when a routing path breaks is as follows. When a node finds that the link to a neighbor node on a routing path breaks while forwarding a data packet, the node tries to find a substitution path to replace the broken link without re-activating the route discovery process. If a substitution path is found, the node modifies the routing information included in the data packet and forwards the packet via the substitution path. The node then sends a route error packet to the source node to inform the source node of the new routing path. If a substitution path cannot be found, the node sends a route error packet to the source node to initiate a route discovery process seeking a new routing path.

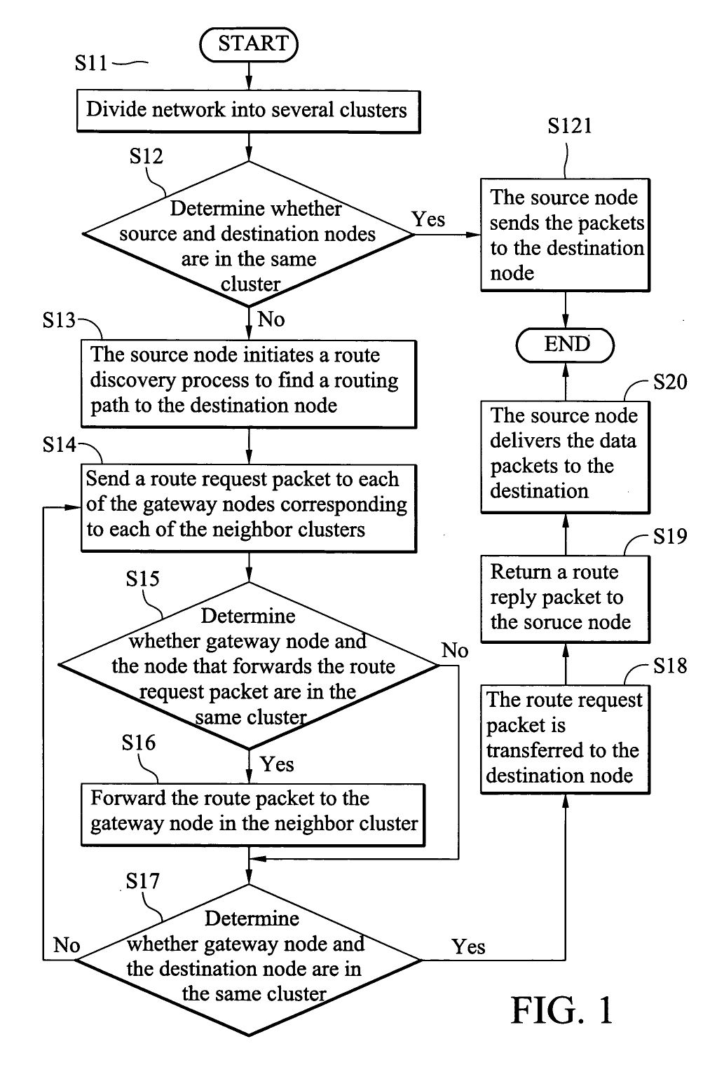

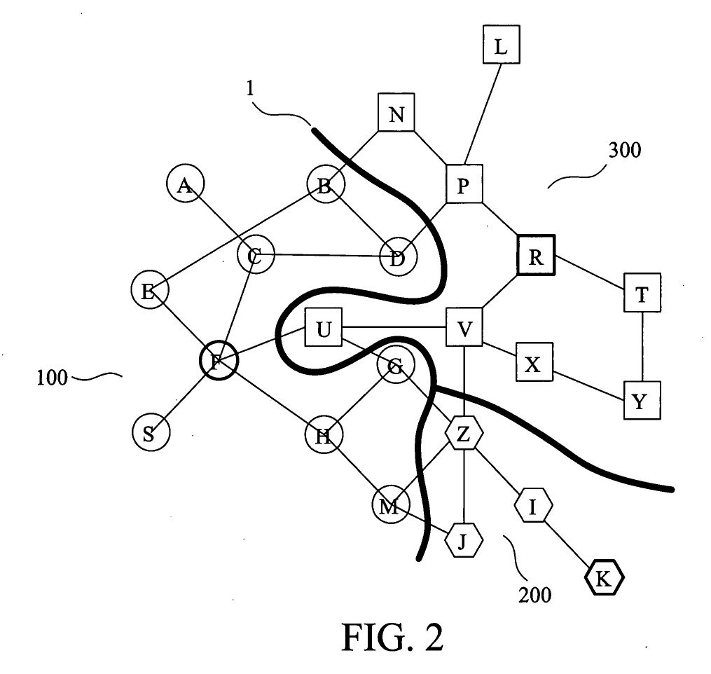

FIG. 1 is a flowchart of the detailed steps of the method for route selection applied in a multihop mobile (or ad hoc) wireless network according to the present invention. An example of the method is described as follows. As shown in FIG. 2, the method of the invention divides an Ad Hoc wireless network into a first cluster 100, a second cluster 200, and a third cluster 300, by a boundary 1 (step S11), in which each cluster comprises a plurality of nodes. The nodes in FIG. 2 are labeled from A to Z. In this embodiment, gateway node M in cluster 100 and gateway node J in cluster 200 are connected to each other, gateway node F in cluster 100 and gateway node U in cluster 300 are connected to each other, and gateway node Z in cluster 200 and gateway node V in cluster 300 are connected to each other.

When node S (source node) wishes to send data packets to node T (destination node), node S determines whether node T is located in cluster 100 (step S12). If node T is located in cluster 100, node S sends the data packets to node T according to the route table thereof (step S121); otherwise, node S initiates a route discovery process to find a routing path to node T (step S13). Node S sends route request packets to gateway nodes F and M according to the gateway table (step S14).

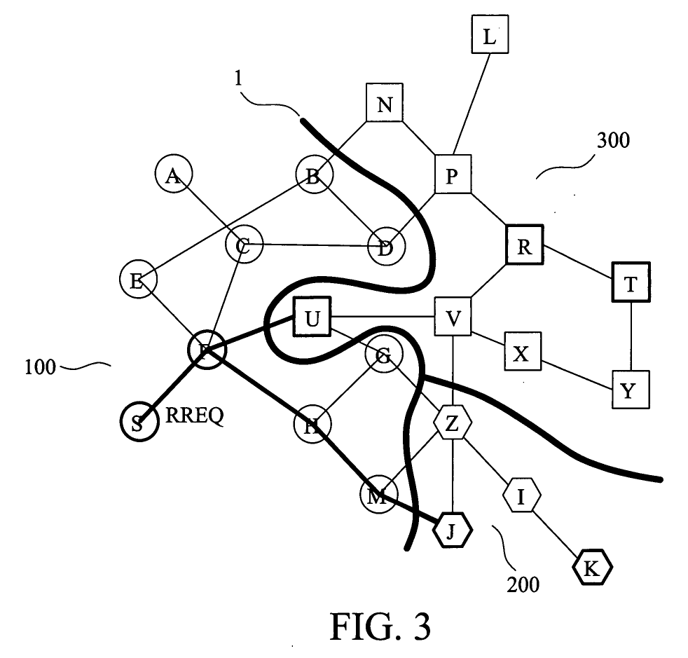

Gateway nodes F and M then respectively determine whether the node that forwards the route request packet resides in the same cluster as it does (step S15). If yes, the gateway node forwards the route request packet to the gateway node in the neighbor cluster (step S16) Thus, in this example, gateway nodes F and M then respectively forward the route request packet to node U, located in cluster 300, and node J, located in cluster 200, as shown in FIG. 3. If not, the process goes to step S17.

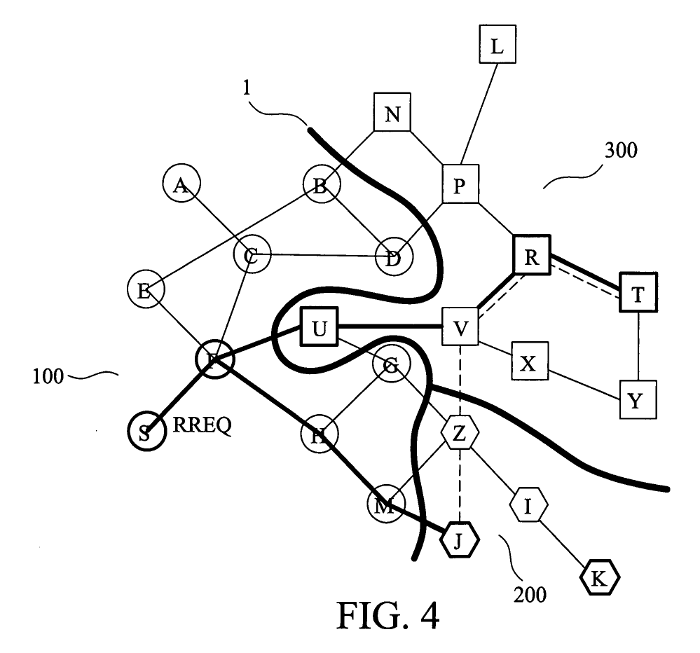

Next, each gateway node determines whether the destination node resides in the same cluster as it does (step S17). If not, the process returns to step S14. Node J determines that node T is not in cluster 200 when receiving the route request packet, and the route request packet is eventually forwarded to node V (gateway node) in cluster 300. If the destination node is within the same cluster, the route request packet is sent to the destination node, (step S18). Nodes U and V send the route request packets to the destination node T respectively when receiving the route request packet, as shown in FIG. 4.

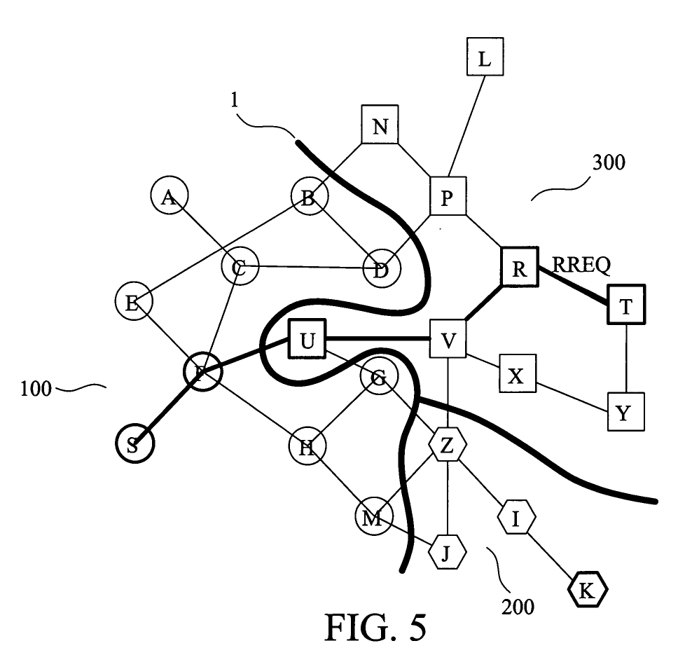

Node T selects one of the routing paths if it receives two or more route request packets. Node T returns a route reply packet to node S according to the routing path recorded in the route request packet (step S19). Node S obtains the routing path to node T when receiving the route reply packet. Node S delivers the data packets to the destination node T (step S20), as shown in FIG. 5.

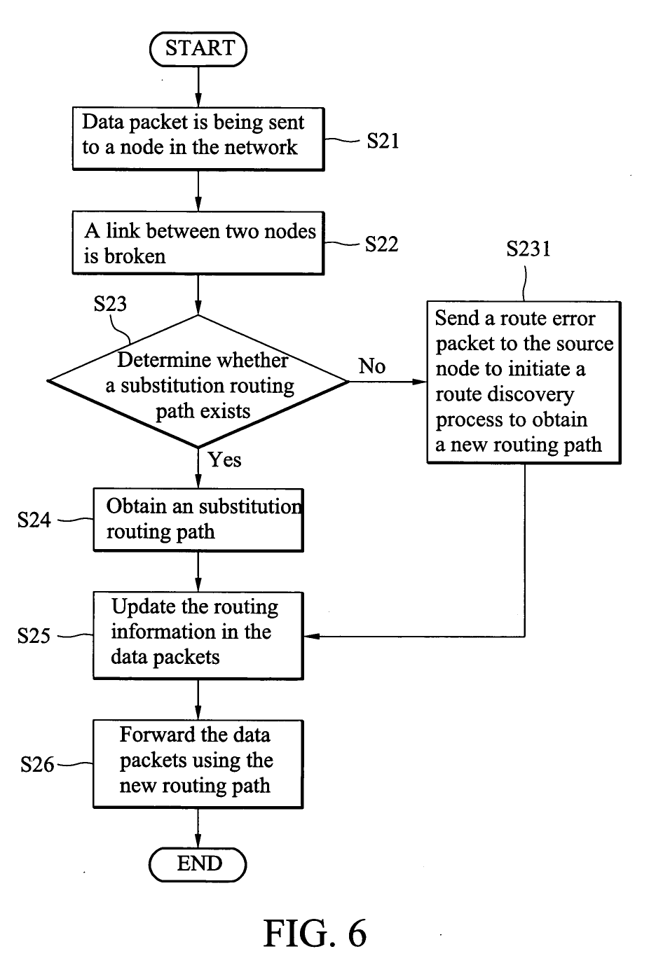

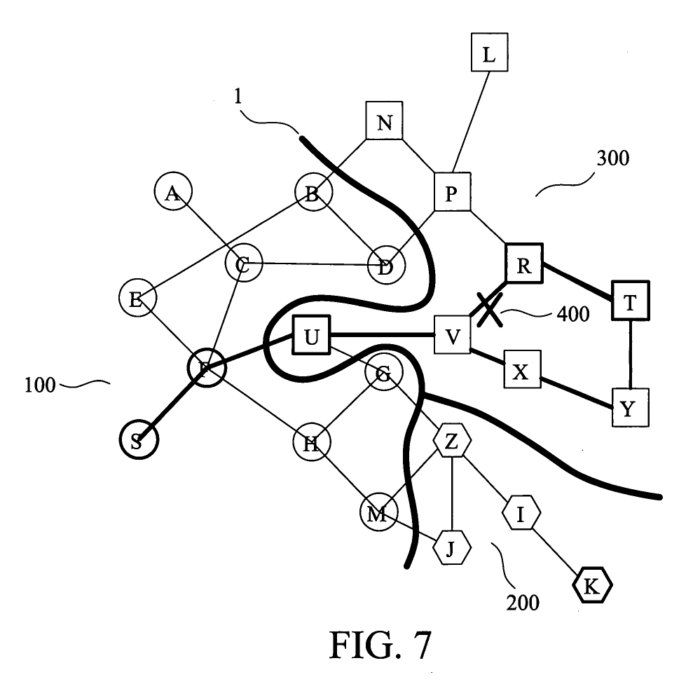

FIG. 6 is a flowchart of the detailed steps of the method for route reconstruction when a link breaks according to the present invention. Consider the previous example where the routing path from node S to node T is S→F→U→V→R→T. Suppose that the connection between nodes V and R is broken when a data packet reaches node V (steps S21 and S22), such that node V cannot forward the data packet to node R according to the routing information recorded in the data packet. Node V then determines whether a substitution routing path between nodes V and R exists according to the route table thereof (step S23). If not, node V sends a route error packet to the source node to initiate a route discovery process to obtain a new routing path (step S231). If so, the substitution routing path V→X→Y→T→R is obtained to replace link 400 (step S24). The new routing path from node S to node R is S→F→U→V→X→Y→T→R→T which includes a loop. Removing the loop, the final substitution routing path is obtained as S→F→U→V→X→Y→T. Node V sends a route error packet with the substitution path included to the source node S. The source node S updates the routing information included in the data packets (step S25). The data packets are forwarded to destination node T using the new routing path (step S26) as shown in FIG. 7.

The method of the invention integrates proactive and reactive routing protocols, dividing an Ad Hoc wireless network into several clusters. The proactive routing protocol maintains complete and the most up to date routing information within a cluster and the reactive routing protocol calculates the routing paths across the boundaries of clusters. In addition, when a link of a routing path breaks, the node that encounters the broken link finds a substitution routing path to replace the broken link, and forwards the data packets using the substitution path.

The method of the present invention uses a clustering algorithm to organize the nodes in a multihop mobile (or ad hoc) wireless network into non-overlapping clusters, thereby reducing the number of messages for maintaining link state information in the network. Furthermore, the link state information within a cluster is used to reconstruct broken routing paths due to changes in topology such that the number of lost packets is significantly reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for route selection, applied in a multihop mobile (or ad hoc) wireless network, comprising the steps of:
creating a plurality of clusters, comprising at least a first cluster connected to a second cluster;
a source node located in the first cluster sending data packets;
the source node determining whether a destination node is in the first cluster according to a link state table of the source node;
the source node obtaining a first route according to a route table thereof if the destination node is in the first cluster, and delivering the data packets to the destination node through the first route;
the source node sending a route request packet to a first gateway node located in the first cluster according to a gateway table thereof if the destination node is not in the first cluster;
the first gateway node forwarding the route request packet to a second gateway in the second cluster;
the second gateway node obtaining a second route to the destination node according to a route table thereof if the destination node is in the second cluster;
the second gateway node forwarding the route request packet to the destination node;
the destination node returning a route reply packet to the source node; and
the source node delivering the data packets to the destination node through the second route.

2. The method as claimed in claim 1, wherein each node comprises a link state table, in which link states of all links within the same cluster are maintained.

3. The method as claimed in claim 1, wherein each node comprises a route table containing the shortest path from the node to each of other nodes within the same cluster.

4. The method as claimed in claim 1, wherein each node comprises a gateway table, in which gateway information of all gateway nodes within the same cluster is maintained.

5. The method as claimed in claim 1, wherein each node comprises a route cache, in which recent complete routes are stored.

6. The method as claimed in claim 1, wherein each cluster comprises a unique cluster ID.

7. The method as claimed in claim 1, wherein each node comprises a unique node ID.

8. The method as claimed in claim 1, wherein the source node delivers the route request packet to the second gateway node through a first gateway node in the first cluster.

9. The method as claimed in claim 8, wherein the first gateway node forwards the route request packet to the second gateway node according to a gateway table thereof.

10. The method as claimed in claim 1, wherein the second gateway node determines that the destination node is in the second cluster according to a link state table thereof.

11. The method as claimed in claim 1, wherein the step of obtaining the second route further comprises of receiving the route request packet at the destination node via the second route.

12. The method as claimed in claim 11, wherein the step of obtaining of the second route further comprises returning a route reply packet from the destination node to the source node through the second route.

13. A method for route reconstruction, determining a substitution path from a first node to a second node when a connection between the first and second nodes is broken while the first node is sending a data packet to the second node, comprising the steps of:
the first node determining whether a substitution path to the second node can be found according to a route table thereof;
the first node delivering the data packet to the destination if the substitution path is found;
adding routing information of the substitution path to a route error packet;
delivering the route error packet to the source node;
the first node sending a route error packet to the source node if the substitution path cannot be found; and
performing a route discovery process to find a new path to the destination node when the source node receives the route error packet.

14. A system for route selection, applied in a multihop mobile (or ad hoc) wireless network, comprising:
a first cluster, comprising a source node and at least a first gateway node, in which the source node sends data packets; and
a second cluster, connected to the first cluster, comprising a destination node and at least a second gateway node,
wherein the source node determines whether the destination node is located in the first cluster according to a link state table thereof, finds a first route according to a route table thereof if the destination node is located in the first cluster, delivers the data packets to the destination node through the first route, sends a route request packet to a first gateway node located in the first cluster according to a gateway table thereof if the destination node is not located in the first cluster, the first gateway node forwards the route request packet to the second gateway node in the second cluster according to the gateway table, and the second gateway node obtains a second route to the destination node according to a route table thereof if the destination node is located in the second cluster, the destination node returns a route reply packet to the source node, and the source node delivers the data packets to the destination node through the second route.

15. The system as claimed in claim 14, wherein each node comprises a link state table, in which link states of all links within the same cluster are maintained.

16. The system as claimed in claim 14, wherein each node comprises a route table, containing the shortest path from the node to each of other nodes within the same cluster.

17. The system as claimed in claim 14, wherein each node comprises a gateway table, in which gateway information of all gateway nodes within the same cluster are maintained.

18. The system as claimed in claim 14, wherein each node comprises a route cache, in which recent complete routes are stored.

19. The system as claimed in claim 14, wherein each cluster comprises a unique cluster ID.

20. The system as claimed in claim 14, wherein each node comprises a unique node ID.

21. The system as claimed in claim 14, wherein the source node delivers the route request packet to the second gateway node through a first gateway node in the first cluster.

22. The system as claimed in claim 21, wherein the first gateway node delivers the route request packet to the second gateway node according to a gateway table thereof.

23. The system as claimed in claim 14, wherein the second gateway node determines that the destination node is located in the second cluster according to a link state table thereof.

24. The system as claimed in claim 14, further comprising the destination node receiving the route request packet through the second route.

25. The system as claimed in claim 14, further comprising the destination node returning a route reply packet to the source node through the second route.
